(19) United States
(12) Patent Application Publication
(10) Pub. No.: US 2007/0158396 A1
(43) Pub. Date: Jul. 12, 2007

(54) Crankshaft arrangement and structural part for said crankshaft arrangement

(76) Inventors: Detlef Lauk, Renchen (DE); Achim Hawighorst, Buehlertal (DE)

Correspondence Address: MICHAEL BEST & FRIEDRICH, LLP, 100 E WISCONSIN AVENUE, Suite 3300, MILWAUKEE, WI, 53202, US

(21) Appl. No.: 10/588,841

(22) PCT Filed: Jan. 28, 2005
(86) PCT No.: PCT/EP05/50364

§ 371 Date: Aug. 8, 2006

(30) Foreign Application Priority Data
Feb. 27, 2004 (DE) 10 2004 009 717.8

(51) Int. Cl. F16C 11/06; B23K 31/02

(52) U.S. Cl. 228/182; 403/11

(57) ABSTRACT

The invention starts with a crankshaft arrangement, especially for a windshield wiper system, in which a shaft (10) is connected to a crank (12) so as to drive it. It is proposed that the crank (12) be connected to the shaft (10) via a structural part (16). In addition, a structural part (16) for a crankshaft arrangement is proposed.

### PRIOR ART

The invention starts with a crankshaft arrangement as well as structural part for a crankshaft arrangement in accordance with the pre-characterizing clauses of Claims 1 and 10.

Crankshaft arrangements, particularly those for windshield wiper systems, are known. Riveting the crank to a shaft or screwing a crank placed on a conical knurl of the shaft to the shaft by means of a nut has already been proposed in order to transfer the torque from a drive unit to a crank. Producing the connection requires a plurality of work steps, for instance thread cutting on the shaft, as well as a relatively long length of the shaft to screw down the nut.

### ADVANTAGES OF THE INVENTION

According to the invention, a crankshaft arrangement is proposed in which a crank is connected to a shaft via a structural part. The structural part forms an intermediate piece between the crank and the shaft, in particular the output shaft, of the motor. If the motor, in particular a driving motor of a windshield wiper system, is completely assembled, the shaft cannot be supported on the crank's driving gearwheel when the crank is pressed on the shaft. The structural part must transmit radial force, which can be guaranteed via a positive engagement by pressing. The shaft can be embodied as a smooth cylinder or as a polygonal element. The structural part can feature an inner knurl made of hardened or an appropriate material so that the knurl presses into the shaft. It is also conceivable for the shaft to have a knurl on its outer side that makes an impression in the structural part during pressing. Furthermore, the shaft and structured part can form a gearing with each other. This is also conceivable for the connection between the crank and the structural part. A person skilled in the art will select a combination for fastening that appears meaningful to him or her.

The structural part can be mounted on the shaft and axially secured on it independent of the crank. Securing can be accomplished by caulking, welding and the like. In addition, a support against a gear housing or a bearing flange can be provided, which protects the shaft and/or a driving gearwheel from axial stress. With subsequent fastening of the crank on the structural part, it is possible to guarantee that the axial stress of the shaft is practically negligible. With a windshield wiper system with this type of crankshaft arrangement, the crank can be mounted without difficulty on the shaft of a driving motor, if this motor is already installed in a wiper system. The shaft can be designed to be shorter overall than is the case with a standard screw fastening, additional work steps for thread cutting on the shaft can be eliminated, and the driving motor is spared axial stress.

It is possible to connect the crank to the structural part simply if the structural part projects with its first fore part into a bore hole of the crank. The crank can be axially secured on the structural part in various ways, for instance by welding, notching, wobbling, by a securing ring, a so-called speed nut and the like. The type of securing can be selected depending upon the need.

It is especially favorable for an assembly of the crank that is easy on the shaft, if the structural part features, on its second fore part, a crosspiece for support on a counter bearing. The counter bearing can be, e.g., a gear housing or a bearing flange of an eccentric bush, on which the crankshaft arrangement is arranged. The structural part supports itself on the counter bearing, and the crank can be pressed on the structural part without the shaft being axially stressed. The crosspiece preferably forms a base of a sleeve extending away from the first and second fore parts in the axial direction. A body lying within the sleeve, like a bearing flange or a gear housing for instance, can provide protection against splashed water. This is especially advantageous in windshield wiper systems. Separate water protection as well as its fastening parts can be eliminated.

The transmission of torque from the shaft to the crank is guaranteed if the structural part is connected to the shaft at least in a rotationally secured manner. For this purpose, the normally round shaft can have a flat surface or an edge on its end that projects into the bore hole of the structural part and the structural part can have a corresponding flat surface or edge in its bore hole. A polygonal contour or even a knurled contour is favorable, whereby the knurl has a plurality of teeth, with a corresponding design of the bore hole of the crank so that rotational security is guaranteed.

The structural part can have a cylindrical outer wall or alternatively an outer wall that tapers towards the first fore part, wherein the outer wall can be embodied to be smooth or as a polygon or knurl.

A favorable axial fixation of the crank on the structural part consists of providing the structural part, on its first fore part, with an edge that can be folded over to the outside in the radial direction. In an assembled state, the edge projects axially away from the first fore part. In a folded-over state, the edge grips over the crank in the area of the bore hole so that the crank is axially fixed on the structural part and therefore on the shaft. If the shaft then has, on its end facing the structural part, a thread with a predetermined breaking point for separating the thread from the shaft, the folding over of the edge can be accomplished in an especially simple and reliable manner by a nut being screwed on. At the same time, the structural part can be advantageously pressed with the crank via the thread by screwing on the nut, without the gear housing or the bearing having to absorb a force. As a result, this also keeps a force from being exerted on the driving gearwheel of the driving motor. The edge of the structural part is thereby folded over to the outside in that, preferably after pressing the crank with the structural part, the nut is screwed further on the thread and the edge is pressed to the outside. The nut is tightened expediently until the thread breaks at the predetermined breaking point.

Furthermore, a structural part for a crankshaft arrangement for connecting a crank to a shaft is proposed, which has a sleeve with a crosspiece on one of its fore parts. The crosspiece makes sure that the axial stress of the shaft is as low as possible during assembly of the crank. The fastening of the crank on the shaft can be accomplished independent of the fastening of the structural part on the shaft.

If the sleeve has, on its fore part opposite from the one fore part, an edge that can be folded over to the outside in the radial direction, the crank can be secured axially by simply folding over the edge on the structural part.

Protection against splashed water can be integrated into the structural part in a simple manner if the crosspiece forms a base of a sleeve extending away from the fore parts in the axial direction. Elements lying within this sleeve are protected from splashed water as much as possible.

### DRAWINGS

The invention is explained in greater detail in the following on the basis of exemplary embodiments without restriction of the generality in the drawings. Independent of the summary in the claims, they also show additional aspects, features and advantages of the invention, which a person skilled in the art will also observe in different, meaningful combinations. The drawings show:

FIG. 1a, b A longitudinal section through a first preferred embodiment (a) of a crankshaft arrangement in accordance with the invention and a second embodiment with an alternative fastening of the structural part (b);

FIG. 2 a-l Always a top view of and section through various preferred embodiments of a structural part;

FIG. 3 A crankshaft arrangement in accordance with the prior art;

FIG. 4 a, b A preferred embodiment of a crankshaft arrangement with an edge that can be folded over, before (a) and after (b) the folding over of the edge, with a conical structural part;

FIG. 5a, b Another preferred embodiment of a crankshaft arrangement with an edge that can be folded over, before (a) and after (b) the folding over of the edge, with a cylindrical structural part.

### DESCRIPTION OF THE EXEMPLARY EMBODIMENTS

The crankshaft arrangement is particularly suitable for a windshield wiper system in which a shaft of a driving motor has a driving connection with a crank in order to drive a wiper element.

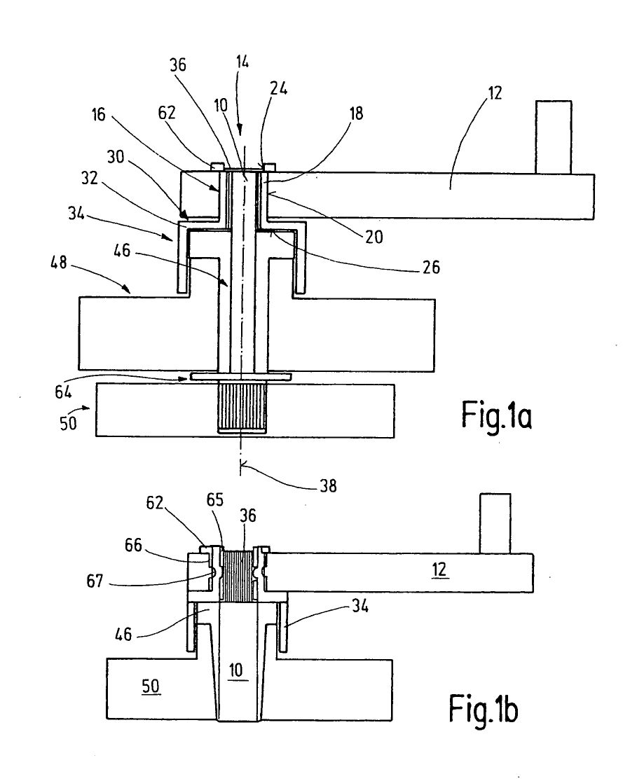

FIG. 1a shows a longitudinal section through a preferred embodiment of a crankshaft arrangement in accordance with the invention. The shaft 10 of a driving motor (not shown) projects through a driving gearwheel 50, a gear housing 48 and an eccentric bush 46 into a bore hole 14 of a crank 12. A spring washer 64 is located between the driving gearwheel 50 and the eccentric bush 46. The shaft 10 ends in a polygonal element 36 embodied as a knurl, which can be an integral part of the shaft 10 or be firmly connected to it, in particular pressed on the shaft 10. A sleeve 18 of a structural part 16 is pressed adherently and positively-engaged on the shaft 10 or on the polygonal element 36.

The structural part 16 projects with its first fore part 24 into the bore hole 14 of the crank 12. The bore hole 14 is adapted expediently to the shape of the outer wall 20 of the structural part 16. Arranged on its second fore part 26 is a crosspiece 30 embodied particularly as a circumferential collar crosspiece, with which the structural part 16 rests on the eccentric bush 46 as a counter bearing. Pressed on the structural part 16 is the crank 12, which is thus connected via the structural part 16 to the polygonal element 36 and therefore to the shaft 10. The crank 12 is secured axially on the structural part 16 by a fixation 62, e.g., a weld.

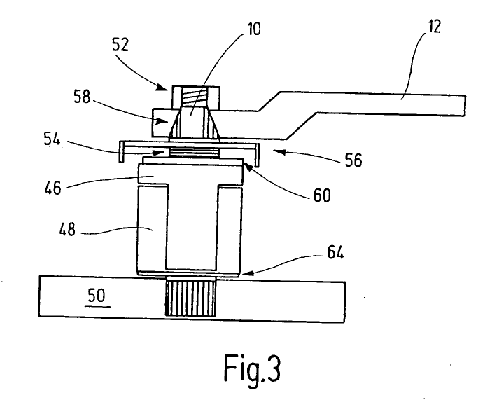

According to a preferred embodiment, the crosspiece 30 forms a base 32 of a sleeve 34 extending away from the first and second fore parts 24, 26 in the axial direction 38 and acts as protection against splashed water for the eccentric bush 46 and the gear housing 48. FIG. 1b, which shows only a section of the arrangement from FIG. 1a, depicts an alternative fastening of the structural part 16 on the shaft 10 or the polygonal element 36. The arrangement corresponds largely to that of FIG. 1a. A polygonal element 65 embodied as a knurl is arranged between the inner wall of the bore hole 14 and the inner wall of the structural part 16. In just the same way, a polygonal element 66 embodied as a knurl is arranged between the outer wall of the structural part 16 projecting into the bore hole 14 and the bore hole 14 of the crank 12. The structural part 16 is secured on the shaft 10 or the polygonal element 36 with a notch 67. In addition, the eccentric bush 46 is embodied conically, and the gear housing 56 [Translator's note: Elsewhere the gear housing is designated “48.” A pot-shaped element in FIG. 3 is “56.”] has a correspondingly adapted opening.

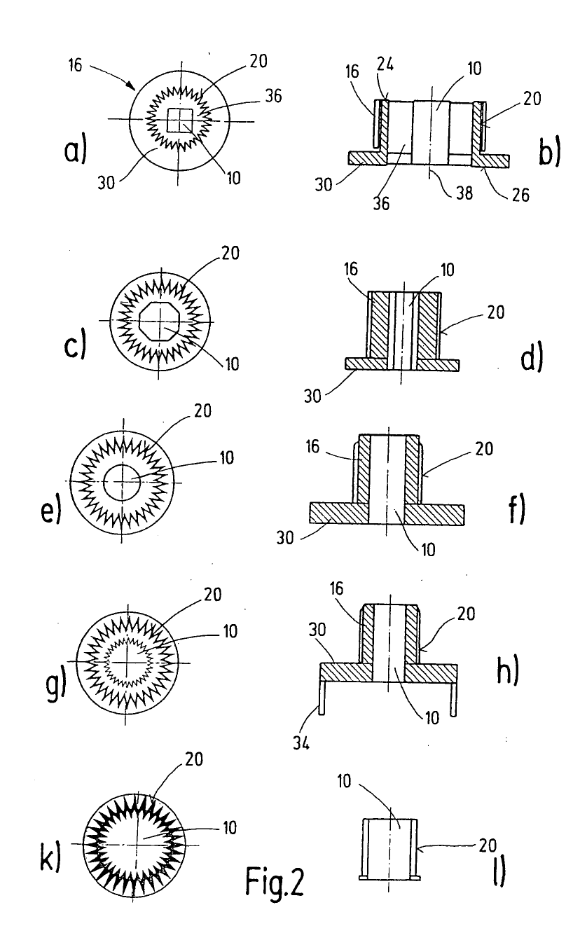

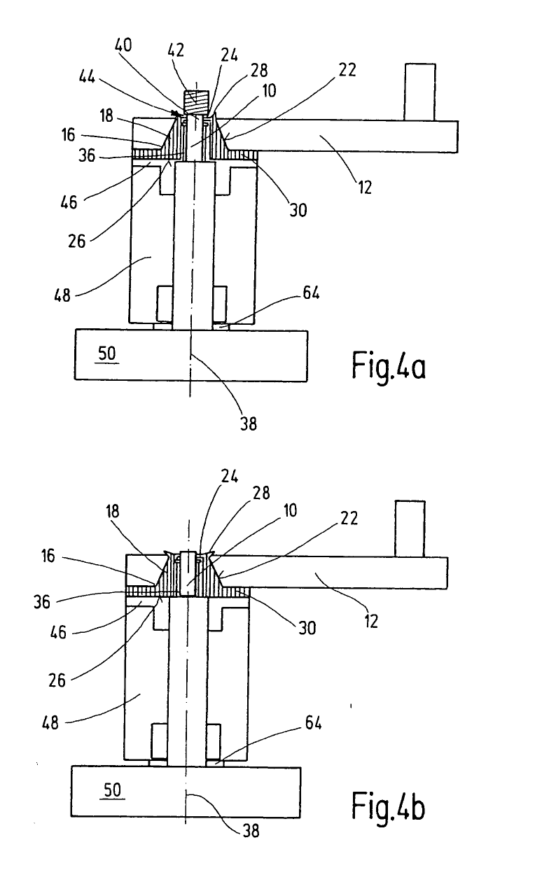

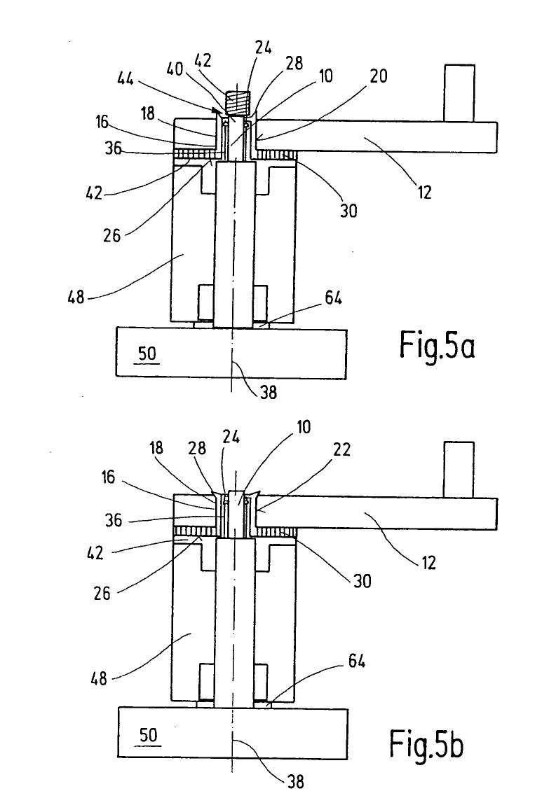

A top view of and a section through various preferred embodiments of a structural part 16 are depicted in FIGS. 2a-l. The top view in FIG. 2a shows a shaft 10 in the center, which is embodied as a square. The shaft 10 is surrounded by a structural part 16, whose outer wall 20 forms a polygonal element 36 embodied as a knurl. The section in FIG. 2bshows the shaft 10 in the center of the structural part 16 and the outer wall 20 of the structural part 16, which has a crosspiece 30 on its second fore part 26 for support on a counter bearing. FIGS. 2c and 2d show a top view and a section, respectively, wherein the shaft 10 is embodied as an octagon and the inner bore hole of the structural part 16 surrounding it correspondingly forms an inner octagon. The outer wall 20 of the structural part 16 is embodied as a knurl. FIGS. 2e and 2f show a top view and a section, respectively, with a cylindrical shaft 10. FIGS. 2g and 2h show a top view and a section, respectively, with an outer wall 20 of the shaft 10 embodied as an outer knurl and a structural part 16 with inner and outer knurls. The structural part 16 in this case optionally features a sleeve 34 as protection against splashed water, something that can be provided on all structural part designs depicted here. FIGS. 2k and 2l show a top view and a section, respectively, with a structural part 16 whose inner bore hole is deep drawn and forms an inner and outer knurl, wherein the shaft 10 also has an outer knurl. Of course, in the case of all the designs, an edge that can be folded over to the outside can be provided on the structural part 16 to axially fix the crank 12 on the structural part 16, as will be described later in FIGS. 4 and 5.

For purposes of comparison, FIG. 3 shows a crankshaft arrangement in accordance with the prior art. A crank 12 with its bore hole 14 surrounds a conical knurl 58, which sits on a shaft 10 of a driving motor (not shown). Arranged beneath the knurl 58 are grooves 54, which are used to fasten a locking element 60 (speed nut) on an eccentric bush 46 connected to a gear housing 48. Beneath the knurl 58 and above the grooves 54, a pot-shaped embodied element 56 is arranged as protection from splashed water, which covers the upper area of the eccentric bush 46. The crank 12 is secured axially on the shaft 10 by a screwed-on fastening nut 52, which is screwed on a thread of the shaft 10. The crankshaft arrangement in accordance with the prior art has a higher construction height due to the fastening nut 52 while the crankshaft arrangement in accordance with the invention is considerably shorter.

FIGS. 4a and 4b show a preferred embodiment of a crankshaft arrangement with an edge 28 that can be folded over, before (a) and after (b) the folding over of the edge 28, with a conical structural part 16. A shaft 10 is passed through a driving gear 50, a gear housing 48, an eccentric bush 46 and the structural part 16, and ends in a polygonal element 36. The polygonal element 36 is firmly connected to the shaft 10, e.g., pressed on, or embodied as a one-part piece with it. The structural part 16 tapers towards its first fore part 24 and is embodied in particular conically. It has an inner bore hole adapted to the polygonal element 36 thereby guaranteeing rotational security. The edge 28 that can be folded over to the outside in the radial direction is arranged on the first fore part 24 of the structural part 16. Arranged on its second fore part 26 is a crosspiece 30 surrounding the lower area of its outer wall 22, and this crosspiece supports the structural part 16 on the eccentric bush 46.

On its end 40 facing the structural part 16, the shaft 10 has a thread 42 with a predetermined breaking point 44 for separating the thread 42 from the shaft 10. When the edge 28 is in an installed state, the crank 12 can be mounted on the structural part 16. In order to press the crank 12 on the structural part 16 and secure it on the shaft 10, a nut (not shown in the drawing) can be screwed on the thread 42, which during tightening first presses the crank 12 on the structural part 16 and then with further tightening displaces the edge 28 to the outside. The nut can be tightened until the thread 42 breaks off at the predetermined breaking point 44 and the arrangement reaches its advantageous, low construction height. This state is shown in FIG. 4b.

FIGS. 5a and 5b show another preferred embodiment of a crankshaft arrangement with an edge 28 that can be folded over, before (a) and after (b) the folding over of the edge 28, with a structural part 16 with a cylindrical outer wall 20. The arrangement corresponds to that in FIG. 4 and the axial securing of the crank 12 is accomplished in the same manner as depicted there. Reference is made to FIG. 4 for the description.

1. Crankshaft arrangement, for a windshield wiper system, in which a shaft (10) is connected to a crank (12) so as to drive the shaft, characterized in that the crank (12) is connected to the shaft (10) via a structural part (16).

2. Crankshaft arrangement according to claim 1, characterized in that the structural part (16) projects with its first fore part (24) into a bore hole (14) of the crank (12).

3. Crankshaft arrangement according to claim 1, characterized in that the structural part (16) features, on its second fore part (26), a crosspiece (30) for support on a counter bearing.

4. Crankshaft arrangement according to claim 3, characterized in that the crosspiece (30) forms a base of a sleeve (34) extending away from the first and second fore parts (24, 26) in the axial direction (38).

5. Crankshaft arrangement according to claim 1, characterized in that the structural part (16) is connected to the shaft (10) at least in a rotationally secured manner.

6. Crankshaft arrangement according to claim 1, characterized in that the structural part (16) has a cylindrical outer wall (20).

7. Crankshaft arrangement according to claim 2, characterized in that the structural part (16) has an outer wall (22) that tapers towards the first fore part (24).

8. Crankshaft arrangement according to claim 2, characterized in that the structural part (16) has, on its first fore part (24), an edge (28) that can be folded over to the outside in the radial direction.

9. Crankshaft arrangement according to claim 1, characterized in that the shaft (10) has, on its end (40) facing the structural part (16), a thread (42) with a predetermined breaking point (44) for separating the thread (42) from the shaft (10).

10. Structural part for a crankshaft arrangement for connecting a crank (12) to a shaft (10), characterized in that a sleeve (18) features a crosspiece (30) on one fore part (26).

11. Structural part according to claim 10, characterized in that the sleeve (18) has, on a fore part (24) opposite from the one fore part (26), an edge (28) that can be folded over to the outside in the radial direction.

12. Structural part according to claim 10 characterized in that the crosspiece (30) forms a base (32) of a sleeve (34) extending away from the fore parts (24, 26) in the axial direction (38).

13. Crankshaft arrangement according to claim 2, characterized in that the structural part (16) features, on its second fore part (26), a crosspiece (30) for support on a counter bearing.

14. Crankshaft arrangement according to claim 13, characterized in that the crosspiece (30) forms a base of a sleeve (34) extending away from the first and second fore parts (24, 26) in the axial direction (38).

15. Crankshaft arrangement according to claim 14, characterized in that the structural part (16) is connected to the shaft (10) at least in a rotationally secured manner.

16. Crankshaft arrangement according to claim 15, characterized in that the structural part (16) has a cylindrical outer wall (20).

17. Crankshaft arrangement according to claim 16, characterized in that the structural part (16) has an outer wall (22) that tapers towards the first fore part (24).

18. Crankshaft arrangement according to claim 17, characterized in that the structural part (16) has, on its first fore part (24), an edge (28) that can be folded over to the outside in the radial direction.

19. Crankshaft arrangement according to claim 18, characterized in that the shaft (10) has, on its end (40) facing the structural part (16), a thread (42) with a predetermined breaking point (44) for separating the thread (42) from the shaft (10).
